(19) United States
(12) Patent Application Publication
(10) Pub. No.: US 2011/0085417 A1
(43) Pub. Date: Apr. 14, 2011

(54) String of Sensor Assemblies Having a Seismic Sensor and Pressure Sensor

(76) Inventor: Daniel Ronnow, Oslo (NO)

(21) Appl. No.: 12/720,188

(22) Filed: Mar. 9, 2010

Related U.S. Application Data
(60) Provisional application No. 61/250,680, filed on Oct. 12, 2009.

(51) Int. Cl. G01V 1/28; G01V 1/36

(52) U.S. Cl. 367/38

(57) ABSTRACT

A system includes an electrical medium and a string of sensor assemblies having corresponding outputs connected to the electrical medium, where at least one of the sensor assemblies includes a seismic sensor to measure seismic waves propagated through a subterranean structure, and a pressure sensor. The sensor assembly further includes at least one matching circuit connected to an output of at least one of the seismic sensor and pressure sensor, where the at least one matching circuit is configured to suppress noise. An output signal of the at least one matching circuit is connected to the electrical medium to produce a combined signal that is representative of characteristics of the subterranean structure and in which the noise is suppressed.

### CROSS REFERENCE TO RELATED APPLICATIONS

This application claims the benefit under 35 U.S.C. §119(e) of U.S. Provisional Application Ser. No. 61/250,680, entitled “String of Seismic Sensors with Geophones and Hydrophones,” filed Oct. 12, 2009, which is hereby incorporated by reference.

### BACKGROUND

Seismic surveying is used for identifying subterranean elements, such as hydrocarbon reservoirs, freshwater aquifers, gas injection zones, and so forth. In seismic surveying, seismic sources are placed at various locations on a land surface or sea floor, with the seismic sources activated to generate seismic waves directed into a subterranean structure.

The seismic waves generated by a seismic source travel into the subterranean structure, with a portion of the seismic waves reflected back to the surface for receipt by seismic receivers (e.g., geophones, accelerometers, etc.). These seismic receivers produce signals that represent detected seismic waves. Signals from the seismic receivers are processed to yield information about the content and characteristic of the subterranean structure.

A typical land-based seismic survey arrangement includes deploying an array of seismic receivers on the ground with the seismic receivers provided in an approximate grid formation. The seismic receivers can be multi-component geophones that enable the measurement of an incoming wavefield in three orthogonal directions (vertical z, horizontal inline x, and horizontal crossline y).

For land-based seismic surveying, various types of unwanted wavefields may be present, including ground-roll noise, such as Rayleigh or Love surface waves. The unwanted wavefields can contaminate seismic data acquired by seismic receivers. Although various conventional techniques exist to remove unwanted wavefields from seismic data, such techniques are relatively complex and may be costly.

### SUMMARY

In general, according to an embodiment, an apparatus includes an electrical medium and a string of sensor assemblies having corresponding outputs connected to the electrical medium, where at least one of the sensor assemblies includes a seismic sensor to measure seismic waves propagated through a subterranean structure, and a pressure sensor. The sensor assembly further includes at least one matching circuit connected to an output of at least one of the seismic sensor and pressure sensor, where the at least one matching circuit is configured to suppress noise. An output signal of the at least one matching circuit is connected to the electrical medium to produce a combined signal that is representative of characteristics of the subterranean structure and in which the noise is suppressed.

Other or alternative features will become apparent from the following description, from the drawings, and from the claims.

### BRIEF DESCRIPTION OF THE DRAWINGS

Some embodiments of the invention are described with respect to the following figures:

FIG. 1 is a schematic diagram of a system including a controller connected to a string of sensor assemblies according to some embodiments;

FIG. 2 is a schematic diagram of an embodiment of a sensor assembly that includes a seismic sensor, a pressure sensor, and matching circuits connected to outputs of the seismic sensor and pressure sensor;

FIG. 3 is a flow diagram of a process of performing a subterranean survey using a string of sensor assemblies according to an embodiment; and

FIG. 4 is a schematic diagram of further details of a sensor assembly having a seismic sensor and a pressure sensor, arranged according to an embodiment.

### DETAILED DESCRIPTION

As used here, the terms “above” and “below”; “up” and “down”; “upper” and “lower”; “upwardly” and “downwardly”; and other like terms indicating relative positions above or below a given point or element are used in this description to more clearly describe some embodiments of the invention. However, when applied to equipment and methods for use in certain orientations, such terms may refer to a left to right, right to left, or diagonal relationship as appropriate.

In accordance with some embodiments, a string of sensor assemblies is provided for performing a seismic survey of a subterranean structure, where at least one of the sensor assemblies includes both a seismic sensor and a pressure sensor to perform noise suppression. The pressure sensor in such an arrangement is able to record mainly noise, such that the data from the pressure sensor in each sensor assembly can be used to develop a noise reference for cleansing seismic data acquired by the corresponding seismic sensor. In some implementations, the pressure sensor is formed using a container filled with a material in which a pressure sensing transducer (e.g., a hydrophone, a piezoelectric element, etc.) is provided. The material in which the pressure sensing transducer is immersed can be a liquid, a gel, or a solid such as sand or plastic.

The noise that is detectable by a sensor assembly according to some embodiments can include ground-roll noise. Ground-roll noise refers to seismic waves produced by seismic sources that travel generally horizontally along a ground surface towards seismic receivers. These horizontally traveling seismic waves, such as Rayleigh waves or Love waves, are undesirable components that can contaminate seismic data. Generally, “noise” refers to any signal component that is unwanted from seismic data (such as data representing reflected signals from subterranean elements). Other types of noise include flexural waves present in data acquired over frozen surfaces such as a body of water or permafrost; or airborne noise caused by the environment such as due to wind, rain, or human activity such as traffic, air blasts, flare noise, or other industrial processes.

Generally, the pressure sensor in a sensor assembly is sensitive to horizontally traveling seismic waves such as ground-roll noise (or other noise listed above), but insensitive to waves reflected from subterranean elements, such as P-waves (compression waves). Each sensor assembly having both a seismic sensor and a pressure sensor has at least one matching circuit that is connected to the output of at least one of the seismic sensor and pressure sensor, where the at least one matching circuit is configured to suppress noise. The output of the at least one seismic sensor or pressure sensor is provided through the at least one matching circuit that applies predefined signal processing, such as signal amplitude adjustment, signal phase adjustment, signal integration, signal differentiation, and so forth. The output of the at least one matching circuit is connected to an electrical medium that connects the string of sensor assemblies to a remote controller.

More specifically, according to some embodiments, each sensor assembly that has both a seismic sensor and a pressure sensor includes two matching circuits, where a first matching circuit is connected to the output of the seismic sensor, and the second matching circuit is connected to the output of the pressure sensor. The matching circuits are configured to match characteristics of the outputs of the seismic sensor and pressure sensor such that the outputs can be combined for suppressing noise. Moreover, the matching circuits are designed to enhance noise suppression. As a result, the combined output (combination of outputs of the seismic and pressure sensors as modified by the respective matching circuits) that is provided to the electrical medium includes seismic data in which noise is suppressed.

The combining of the outputs of the matching circuits is accomplished using a combining circuit. In one example, the combining circuit is a short circuit to hardwire the outputs of the matching circuits to the electrical medium. In other examples, other types of combining circuits configured to combine outputs of the matching circuits can be used. The combined signal (representing the combination of the outputs of the two matching circuits) contains the seismic data measured by the seismic sensor, with noise suppressed.

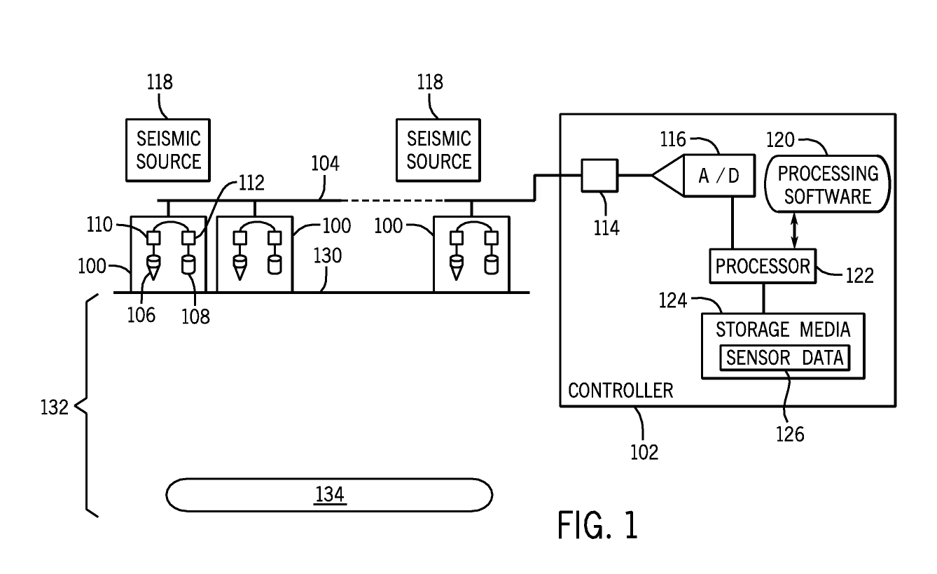

FIG. 1 is a schematic diagram of an arrangement of sensor assemblies 100 that are connected as a string to a controller 102. The string of sensor assemblies 100 are connected to an electrical medium 104, which can be an electrical cable having one or more electrically conductive wires. As shown, each of the sensor assemblies 100 includes a seismic sensor 106 (e.g., geophone, accelerometer, optical sensor, velocity sensor, motion sensor, etc.) and a pressure sensor 108 (e.g., hydrophone, piezoelectric sensor, etc.).

Although each of the sensor assemblies 100 shown in FIG. 1 includes both a seismic sensor and a pressure sensor, it is noted that some of the sensor assemblies 100 may not include both a seismic sensor and the pressure sensor—such sensor assemblies can include just seismic sensors. In one example of such an alternative implementation, the string of sensor assemblies 100 can include multiple sensor assemblies with just seismic sensors, and another sensor assembly with just a pressure sensor. In another example, the string of sensor assemblies 100 can include multiple sensor assemblies with just pressure sensors, and another sensor assembly with just a seismic sensor.

The output of the seismic sensor 106 is connected to an input of a first matching circuit 110, and the output of the pressure sensor 108 is connected to an input of a second matching circuit 112. The outputs of the matching circuits 110 and 112 are hardwired (short circuited) together, or alternatively, combined electronically using some other type of a combining circuit. The combined signal is connected to the electrical medium 104, and provided to the controller 102.

FIG. 1 shows that the string of sensor assemblies 100 is deployed on a ground surface 130 for performing land-based seismic surveying. A sensor assembly 100 being “on” a ground surface means that the sensor assembly 100 is either provided on and over the ground surface, or buried (fully or partially) underneath the ground surface such that the sensor assembly 100 is with 10 meters of the ground surface. The ground surface 130 is above a subterranean structure 132 that contains at least one subterranean element 134 of interest (e.g., hydrocarbon reservoir, freshwater aquifer, gas injection zone, etc.).

One or more seismic sources 118, which can be vibrators, air guns, explosive devices, and so forth, are deployed in a survey field in which the sensor assemblies 100 are located. Activation of the seismic sources 118 causes seismic waves to be propagated into the subterranean structure 132. Alternatively, instead of using controlled seismic sources as noted above to provide controlled source or active surveys, some embodiments can also be used in the context of passive surveys. Passive surveys use the sensor assemblies 100 to perform one or more of the following: (micro)earthquake monitoring; hydro-frac monitoring where microearthquakes are observed due to rock failure caused by fluids that are actively injected into the subsurface, such as a hydrocarbon reservoir; and so forth.

Seismic waves reflected from the subterranean structure 132 (and from the subterranean element 134 of interest) are propagated upwardly towards the sensor assemblies 100. The seismic sensors 106 in the corresponding sensor assemblies 100 measure the seismic waves reflected from the subterranean structure 132. Moreover, any noise impacting the sensor assemblies 100 are measured by the pressure sensors 108, which are designed to measure ground-roll noise or other types of noise.

The controller 102 includes a matching circuit 114 to match the impedance of the electrical medium 104 to an impedance of an analog-to-digital (A/D) converter 116, also in the controller 102. The controller 102 further includes processing software 120 that is executable on a processor 122. The processor 122 is connected to storage media 124 (e.g., one or more disk-based storage devices and/or one or more memory devices). The storage media 124 is used to store sensor data 126, which is based on combined signals from each of the sensor assemblies 100.

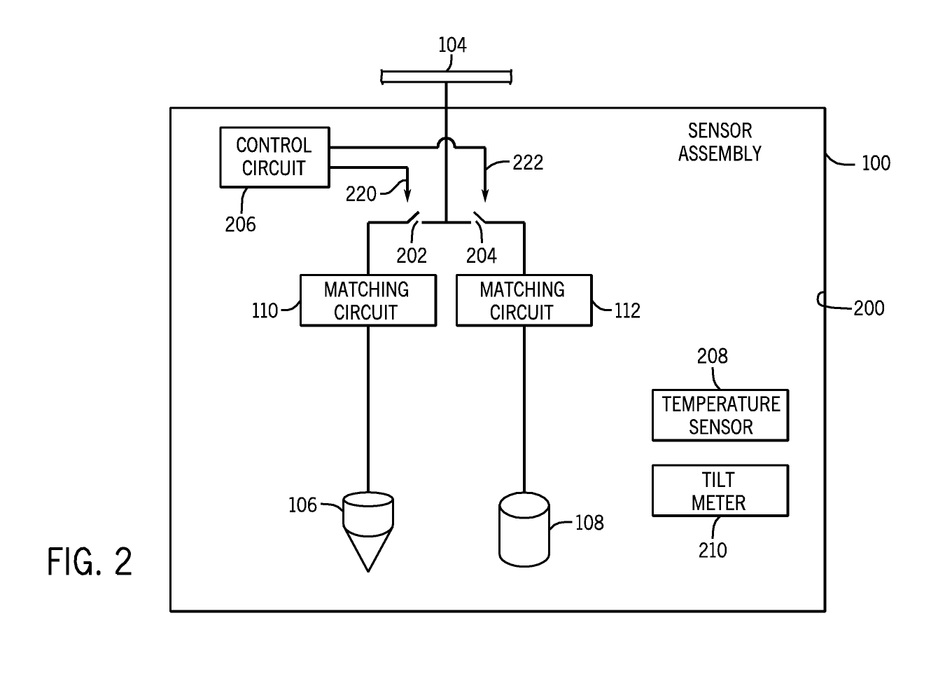

FIG. 2 is a schematic diagram of further components of the sensor assembly 100 located within a housing structure 200 of the sensor assembly 100. A “housing structure” can refer to a single housing, or to multiple housings. For example, in some implementations, the seismic sensor 106 and pressure sensor 108 are contained in separate housings that are part of the housing structure 200. Alternatively, in other implementations, the seismic sensor 106 and pressure sensor 108 are contained within the same housing.

In addition to the seismic sensor 106, pressure sensor 108, first and second matching circuits 110, 112, the sensor assembly 100 also includes switches 202 and 204 connected to respective outputs of the matching circuits 110 and 112. The switches 202 and 204 are controlled by a control circuit 206 in the sensor assembly 100.

The control circuit 206 can be responsive to control signals provided over the electrical medium 104 (such as by the controller 102 of FIG. 1) to selectively activate or deactivate the switches 202 and 204. As depicted in FIG. 2, the control circuit 206 provides control signals 220 and 222 to respective switches 202 and 204 to activate or deactivate the switches. When activated, a switch 202 or 204 electrically connects the corresponding matching circuit 110 or 112 to the electrical medium 104. When deactivated, a switch 202 or 204 electrically isolates the corresponding matching circuit 110 or 112 from the electrical medium 104.

The presence of the switches 202 and 204 allows for selective electrical connection of outputs of the seismic sensor 106 and pressure sensor 108 (as modified by matching circuits 110 and 112, respectively) to the electrical medium 104. The control circuit 206 can selectively activate just one of the switches 202 and 204, or both of the switches 202 and 204.

The sensor assembly 100 further includes a temperature sensor 208 and/or a tilt meter 210. The temperature sensor 208 is used for performing temperature measurement of an environment around the sensor assembly 100. The tilt meter 210 is used for measuring a tilt of the sensor assembly 100 with respect to a reference dimension (e.g., horizontal). The temperature measured by the temperature sensor 208 and/or the tilt measured by the tilt meter 210 can be used to adjust processing characteristics of the matching circuits 110 and 112, such that these matching circuits can be made to be temperature dependent and/or tilt dependent. This allows adjustment of the processing performed by the matching circuits 110 and 112 to account for the environment of the sensor assembly 100. The characteristics of the matching circuits 110 and 112 can also be based on the geometry of the planted sensor assemblies.

Each matching circuit 110 and 112 can include passive and/or active electronic components. In some embodiments, these components can perform adjustment of signal amplitudes and/or signal phases. Thus, for example, the matching circuit 110 can adjust the amplitude and/or phase of the signal output by the seismic sensor 106, while the matching circuit 112 can be used to adjust the amplitude and/or phase of the signal produced by the pressure sensor 108. Adjusting the amplitude of a signal can include adjusting a voltage level, current level, and/or polarity of the signal.

In addition, or alternatively, each matching circuit 110 and 112 can also include an integrator (to integrate a signal) and/or a differentiator (to apply differentiation to a signal). Note that the different types of sensors (seismic sensor 106 and pressure sensor 108) can have different frequency dependencies, such that integration and/or differentiation is applied to the output of the corresponding sensor to match the two outputs of the seismic sensor 106 and pressure sensor 108.

The matching circuits 110 and 112 are designed to match respective transfer functions of the seismic and pressure sensors 106 and 108. By matching the signals output by the seismic and pressure sensors 106 and 108, these output signals can be effectively combined. In addition, the transfer functions of the matching circuits 110 and 112 are determined based on the responses of the seismic sensor 106 and pressure sensor 108, respectively, to noise (e.g., ground-roll noise). This can be determined experimentally, for example. Note also that the response of the seismic sensor 106 can depend on the material and shape of the housing of the seismic sensor 106.

Each matching circuit can be determined or designed based on one or more of the following: the pressure sensor's or seismic sensor's response to coherent noise, such as ground-roll noise; theoretical model(s); and field tests. The matching circuits can be changed, modified, and/or optimized based on local noise characteristics.

For noise cancellation, the matching circuits 110 and 112 are configured such that their output signals have opposite polarities or opposite phases. In this manner, since the pressure sensor 108 records mainly noise, and the seismic sensor 106 records both target data (that represents the subterranean structure 132) and noise, the combination of the outputs of the matching circuits 110 and 112 results in cancellation or suppression of the noise component, such that the combined output provided to the electrical medium 104 includes the target data with noise suppressed.

Although two matching circuits are shown in the example of FIG. 2, note that just one matching circuit can be provided, where the one matching circuit is connected to the output of the seismic sensor 106 or pressure sensor 108, depending on the implementation. In this alternative implementation, the output of the matching circuit is combined with the direct output of the one of the seismic sensor 106 or pressure sensor 108 whose output is not connected through a matching circuit.

Note also that different matching circuits can be provided for different environments, such as different environments based on soil type, subterranean geology, planting technique of the sensor assemblies, and type of source. In some embodiments, the matching circuits 110 and 112 within a sensor assembly 100 are removably connected matching circuits that can be easily removed and replaced with different matching circuits. The matching circuits can be provided on a circuit board or other electronic card, for example, for ease of insertion and detachment from the sensor assembly 100.

In another embodiment, instead of providing one matching circuit for each of the seismic sensor 106 and pressure sensor 108, a respective set of multiple matching circuits can be provided for each of the seismic sensor 106 and pressure sensor 108. Switches (or multiplexers) can be provided to enable selection of one of the matching circuits in each set for the corresponding one of the seismic sensor 106 and pressure sensor 108. For example, in such implementations, the control circuit 206 of FIG. 2 can select one of multiple matching circuits in a first set for the seismic sensor 106, and select one of multiple matching circuits in a second set for the pressure sensor 108. In such implementations, box 110 in FIG. 2 represents the first set, and box 112 in FIG. 2 represents the second set.

The sensor string of FIG. 1 can provide a single-channel electrical medium, or alternatively, a dual-channel medium. With a single-channel implementation, the output signals from all the sensor assemblies 100 of the string are coupled to the same channel and provided to the controller 102. In the dual-channel implementation, two different types of data can be provided: data in the analog domain and data in the digital domain. In the dual-channel implementation, some of the sensor assemblies 100 provide analog outputs, while others of the sensor assemblies 100 provide digital outputs.

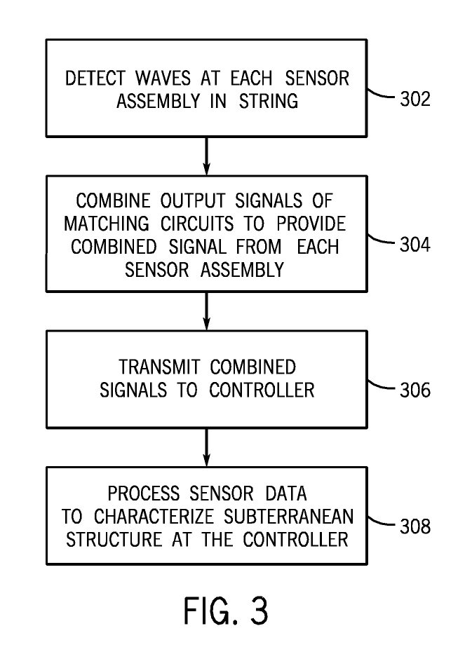

FIG. 3 is a flow diagram of a general process according to an embodiment. Waves (including seismic waves propagated through the subterranean structure and horizontally traveling waves at the surface) are detected (at 302) by each sensor assembly 100 in the string of sensor assemblies. The seismic waves that are propagated through the subterranean structure are detected by the seismic sensor 106 of each sensor assembly 100, while the horizontally traveling waves (or other types of noise waves) are detected by the pressure sensor in each sensor assembly 100.

The signals detected by the seismic sensor 106 and pressure sensor 108 are provided through respective matching circuits (110 and 112), and the output signals of the matching circuits are combined (at 304) to produce a combined signal from each sensor assembly. The combined signals of the sensor assemblies 100 are then transmitted (at 306) to the controller 102.

The controller 102 processes (at 308) the sensor data to characterize the subterranean structure. In some embodiments, the processing performed at the controller 102 can employ a noise suppression algorithm to suppress any remaining parasitic noise resulting from imperfect coupling and matching at the sensor assemblies 100.

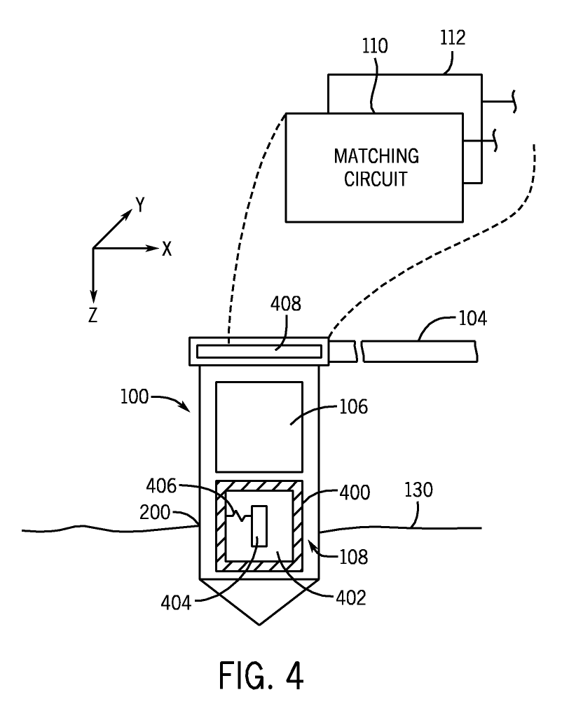

A sensor assembly 100 according to some embodiments is depicted in greater detail in FIG. 4. The seismic sensor 106 in the sensor assembly can be a geophone for measuring particle velocity induced by seismic waves in the subterranean structure 102, or alternatively, the seismic sensor 106 can be an accelerometer for measuring acceleration induced by seismic waves propagated through the subterranean structure 102. An accelerometer can be a geophone accelerometer or a MEMS (microelectromechanical system) accelerometer. In other implementations, other types of seismic sensors can be used, such as optical sensors, velocity sensors, or motion sensors. The motion sensor can be a three-axis MEMS sensor.

The pressure sensor 108 that is also part of the sensor assembly 100 (within the housing structure 200 of the sensor assembly 100) is used for measuring an input (e.g., noise) different from the seismic waves propagated through the subterranean structure 102 that are measured by the seismic sensor 106.

The pressure sensor 108 has a closed container 400 that is sealed. The container 400 contains a volume of liquid 402 (or other material such as a gel or a solid such as sand or plastic) inside the container 400. Moreover, the container 400 contains a hydrophone 404 (or other type of pressure sensing transducer) that is immersed in the liquid 402 (or other material). The pressure sensing transducer being immersed in the material means that the pressure sensing transducer is surrounded by or otherwise attached to or in contact with the material. In the ensuing discussion, reference is made to the hydrophone 404 that is immersed in the liquid 402—note that in alternative embodiments, other types of pressure sensing transducers can be immersed in other types of material. The hydrophone 404, which is neutrally buoyantly immersed in the liquid 402, is mechanically decoupled from the walls of the container 400. As a result, the hydrophone 404 is sensitive to just acoustic waves that are induced into the liquid 402 through the walls of the container 400. To maintain a fixed position, the hydrophone 404 is attached by a coupling mechanism 406 that dampens propagation of acoustic waves through the coupling mechanism 406.

In an alternative embodiment, instead of using the hydrophone 406 in the pressure sensor 114, a piezoelectric transducer element can be used instead.

Examples of the liquid 402 include the following: kerosene, mineral oil, vegetable oil, silicone oil, and water. In other embodiments, other types of liquids can be employed. A liquid with a higher viscosity can be used to change the sensitivity to different types of waves, including P (compression) waves, S (shear) waves, Rayleigh waves, and Love waves. Moreover, the amount of liquid 402 provided in the container 400 of the pressure sensor 108 determines the sensitivity of the hydrophone 404. A container 400 that is only partially filled with liquid records a weaker signal. In some embodiments, the container 400 can be partially filled with liquid to provide an expansion volume within the container 400. Expansion of the liquid 402, such as due to a temperature rise of the liquid 402, can be accommodated in the expansion volume (which can be filled with a gas).

As further shown in FIG. 4, the sensor assembly 100 also includes electronic circuitry 408 that is electrically coupled to both the seismic sensor 106 and the pressure sensor 108. The electronic circuitry 408 includes the components shown in FIG. 2, such as the matching circuits 110, 112 and related circuitry. The electronic circuitry 408 is able to communicate the filtered data acquired by the seismic sensor 106 and pressure sensor 108 over the electrical medium 104 to the controller 102 (FIG. 1).

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. An apparatus comprising:
an electrical medium; and
a string of sensor assemblies having corresponding outputs connected to the electrical medium, wherein at least one of the sensor assemblies includes:
a seismic sensor to measure seismic waves propagated through a subterranean structure;
a pressure sensor;
at least one matching circuit connected to an output of at least one of the seismic sensor and pressure sensor, wherein the at least one matching circuit is configured to suppress noise,
wherein an output signal of the at least one matching circuit is connected to the electrical medium to produce a combined signal that is representative of characteristics of the subterranean structure and in which the noise is suppressed.

2. The apparatus of claim 1, wherein the at least one matching circuit includes a first matching circuit and a second matching circuit, wherein the first matching circuit is connected between the seismic sensor and the electrical medium, and wherein the second matching circuit is connected between the pressure sensor and the electrical medium.

3. The apparatus of claim 2, wherein the first and second matching circuits are configured to adjust one or more of amplitudes and phases of respective signals output by the seismic sensor and pressure sensor.

4. The apparatus of claim 2, further comprising a combining circuit to combine output signals of the first and second matching circuits to cancel the noise detected by the seismic sensor and pressure sensor.

5. The apparatus of claim 4, wherein the combining circuit to combine the output signals of the first and second matching circuits comprises a circuit to hardwire the output signals of the first and second matching circuits together.

6. The apparatus of claim 2, wherein the at least one sensor assembly further comprises a first analog-to-digital converter between the seismic sensor and the first matching circuit, and a second analog-to-digital converter between the pressure sensor and the second matching circuit.

7. The apparatus of claim 2, further comprising:
a first switch connected between the first matching circuit and the electrical medium;
a second switch connected between the second matching circuit and the electrical medium; and
a control circuit configured to selectively activate or deactivate the first and second switches.

8. The apparatus of claim 1, wherein the at least one sensor assembly further comprises:
a plurality of different matching circuits including the at least one matching circuit; and
a switch to select the at least one matching circuit from among the plurality of matching circuits, wherein selection of the at least one matching circuit is based on response of the seismic sensor or pressure sensor to the noise.

9. The apparatus of claim 1, wherein the at least one matching circuit is one of an analog matching circuit and a digital matching circuit.

10. The apparatus of claim 1, wherein the plurality of sensor assemblies form a string of the sensor assemblies, wherein the electrical medium is part of the string, and wherein the electrical medium provides a single channel to carry signals of the plurality of sensor assemblies.

11. The apparatus of claim 1, wherein the plurality of sensor assemblies form a string of the sensor assemblies, wherein the electrical medium is part of the string, and wherein the electrical medium provides a dual channel to carry signals of the plurality of sensor assemblies, and wherein the dual channel carries the signals in both an analog domain and digital domain.

12. The apparatus of claim 1, wherein the at least one sensor assembly further comprises a temperature sensor to measure a temperature to allow for compensation of a transfer function of the seismic sensor or the pressure sensor for a temperature of the at least one sensor assembly.

13. The apparatus of claim 1, wherein the at least one sensor assembly further comprises a tilt meter to measure a tilt of the at least one sensor assembly to allow for compensation of a transfer function of the seismic sensor or the pressure sensor for the tilt of the at least one sensor assembly.

14. The apparatus of claim 1, wherein at least another one of the sensor assemblies comprises a seismic sensor, a pressure sensor, and at least one matching circuit connected to an output of one of the seismic sensor and pressure sensor to provide noise suppression for the at least another sensor assembly.

15. A sensor assembly comprising:
a seismic sensor to measure seismic waves propagated through a subterranean structure;
a pressure sensor;
a first matching circuit connected to an output of the seismic sensor;
a second matching circuit connected to an output of the pressure sensor; and
a combining circuit configured to combine outputs of the first and second matching circuits to provide a combined signal, wherein the combined signal is representative of characteristics of the subterranean structure, and wherein noise experienced by the seismic sensor and pressure is suppressed in the combined signal.

16. The sensor assembly of claim 15, wherein the first and second matching circuits are configured match respective outputs of the seismic and pressure sensors.

17. The sensor assembly of claim 15, wherein the first and second matching circuits are configured to adjust one or more of amplitudes and polarities of the outputs of the seismic sensor and pressure sensor to cause noise suppression when the outputs of the first and second matching circuits are combined by the combining circuit.

18. A method comprising:
deploying a string of sensor assemblies on a ground surface;
connecting the sensor assemblies to an electrical medium;
activating at least one seismic source;
detecting seismic waves by seismic sensors in at least some of the sensor assemblies;
detecting noise by at least one pressure sensor in at least one of the sensor assemblies; and
combining an output of the at least one pressure sensor with an output of at least one of the seismic sensors to cause suppression of noise, wherein a matching circuit is provided to modify the output of the at least one pressure sensor or the output of the at least one seismic sensor to enable the noise suppression caused by the combining.

19. The method of claim 18, wherein the pressure sensor, at least one seismic sensor and matching circuit are located within a housing structure of one of the sensor assemblies.

20. The method of claim 18, further comprising communicating outputs of the sensor assemblies over the electrical medium to a controller.

21. The method of claim 18, further comprising designing the matching circuit based on one or more of: the seismic sensor's or pressure sensor's response to noise; a theoretical model; and a field test.
